(19) United States
(12) Patent Application Publication
(10) Pub. No.: US 2009/0261571 A1
(43) Pub. Date: Oct. 22, 2009

(54) METHOD AND APPARATUS FOR PRINTING TRAVEL DOCUMENTS

(75) Inventors: John A. Dungan, Tulsa, OK (US); William Henry Herleth, Owasso, OK (US)

Correspondence Address: PRASS LLP, 2661 Riva Road, Bldg. 1000, Suite 1044, ANNAPOLIS, MD, 21401, US

(73) Assignee: ARINC INCORPORATED, Annapolis, MD (US)

(21) Appl. No.: 12/105,824

(22) Filed: Apr. 18, 2008

(51) Int. Cl. B42D 15/10

(52) U.S. Cl. 283/70

(57) ABSTRACT

This disclosure concerns a method and apparatus that prints travel documents. The method may include retrieving a travel document template, wherein the travel document template is in a format dictated by an industry standard, receiving travel document data for an individual's travel, integrating the individual's travel document data with the travel document template to produce a digital image of one or more travel documents that includes the integrating travel document data and the travel document template, and outputting the one or more travel document.

### BACKGROUND

1. Field of the Disclosure

This disclosure concerns printing of travel documents.

2. Introduction

Airline document standards for layout and data transmission are described by an industry standard known as Association of European Airlines (AEA). Airline departure control systems send AEA formatted data to printers which must include AEA firmware to translate the format into a readable document. Because of this tightly coupled relationship, airline industry printer and paper suppliers are restricted to niche specialists, increasing the cost of equipment and paper in comparison with mainstream solutions.

This arrangement also makes the development of any changes to airlines documents very expensive and time consuming. This problem is especially apparent when the industry tries to introduce common elements, such as security marks.

### SUMMARY OF THE DISCLOSURE

This disclosure concerns a method and apparatus that prints travel documents. The method may include retrieving a travel document template, wherein the travel document template is in a format dictated by an industry standard, receiving travel document data for an individual's travel, integrating the individual's travel document data with the travel document template to produce a digital image of one or more travel documents that includes the integrating travel document data and the travel document template, and outputting the one or more travel document.

### BRIEF DESCRIPTION OF THE DRAWINGS

FIG. 1 illustrates a diagram of an exemplary travel document printing system in accordance with embodiments of the disclosure;

FIG. 2 illustrates a block diagram of an travel document printing unit in accordance with embodiments of the disclosure; and

FIG. 3 illustrates a flowchart of an exemplary travel document printing process in accordance with embodiments of the disclosure.

### DETAILED DESCRIPTION

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure comprises a variety of embodiments, such as a method and apparatus and other embodiments that relate to the basic concepts of the disclosure. This disclosure may concern a personal computer (PC) based application for receiving Association of European Airlines (AEA) data and rendering the images as they would appear if printed by an AEA printer. The renderings can be transformed into many mainstream formats, such as Microsoft Word, Adobe PDF, and bitmap files, for example. This process may allow documents to be printed on standard equipment, such as office laser printers, which may be remote or local. This also eliminates the need for paper with specialized sizes or coatings.

Additional benefits of this technology includes the ability create the image for sending via email and the ability to add to or alter the image for additional benefits, such as adding security marks, logos, and advertising.

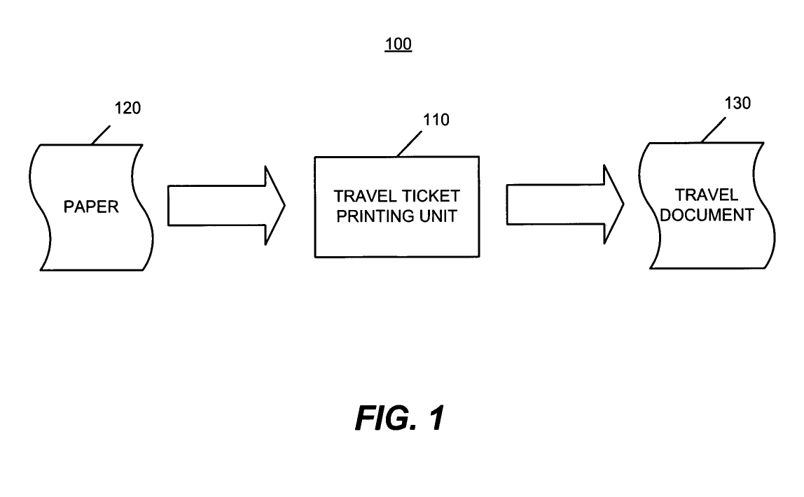

FIG. 1 illustrates a diagram of a travel document printing system 100 in accordance with embodiments of the disclosure. The travel document printing system 100 may include a travel document printing unit 110 that may take ordinary paper 120 and generate one or more travel documents 130 containing travel and AEA data. The travel documents 130 may then be used to gain access to a travel platform, such as a plane, train, cruise ship, etc.

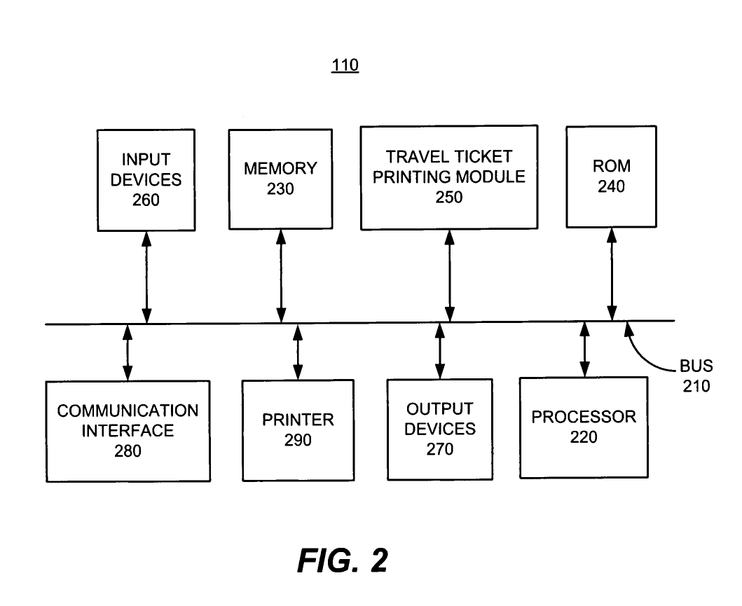

FIG. 2 illustrates a block diagram of the travel document printing unit 110 in accordance with embodiments of the disclosure. The travel document printing unit 110 may be embodied within devices such as a desktop computer, a laptop computer, a handheld computer, a handheld communication device, or another type of computing device, or the like. The travel document printing unit 110 may include a bus 210, processor 220, memory 230, read-only memory (ROM) 240, travel document printing module 250, input devices 260, output devices 270, communication interface 280, and travel document printer 290. The bus 210 may permit communication and transfer of signals among the components of the travel document printing unit 110.

Processor 220 may include at least one conventional processor or microprocessor that interprets and executes instructions. The processor 220 may be a general purpose processor or a special purpose integrated circuit, such as an ASIC, and may include more than one processor section. Additionally, the travel document printing unit 110 may include a plurality of processors 220.

Memory 230 may be a random access memory (RAM) or another type of dynamic storage device that stores information and instructions for execution by processor 220. ROM 240 may include a conventional ROM device or another type of static storage device that stores static information and instructions for processor 220. The memory 230 and ROM 240 may be any memory device that stores data for use by the travel document printing unit 110.

Input devices 260 may include one or more conventional input mechanisms that permit a user to input information to the travel document printing unit 110, such as a microphone, touchpad, keypad, keyboard, mouse, pen, stylus, voice recognition device, buttons, and the like, and/or interfaces for the above. Output devices 270 such as one or more conventional mechanisms that output information to the user, including a display, one or more speakers, a storage medium, such as a memory, magnetic or optical disk, disk drive, a printer device, and the like, and/or interfaces for the above.

Communication interface 280 may include any mechanism that facilitates communication via one or more communications network. For example, communication interface 280 may include a modem. Alternatively, communication interface 280 may include other mechanisms in communicating with other devices and/or systems via wireless connections.

Printer 290 may represent any commercial or standard printer known to one of skill in the art. In this manner, the disclosure describes a process below such that a specialized (and hence, expensive) printer and printer driver are not needed to print travel document. As such, any ordinary printer, such as a laser or ink jet printer may be used within the spirit and scope of the disclosure.

The travel document printing unit 110 may perform functions in response to processor 220 by executing sequences of instructions or instruction sets contained in a computer-readable medium, such as, for example, memory 230. Such instructions may be read into memory 230 from another computer-readable medium, such as a storage device, or from a separate device via communication interface 280, or may be downloaded from an external source such as the Internet. The travel document printing unit 110 may be a stand-alone system, such as a personal computer, or may be connected to a network such as an intranet, the Internet, and the like. Other elements may be included with the travel document printing unit 110 as needed.

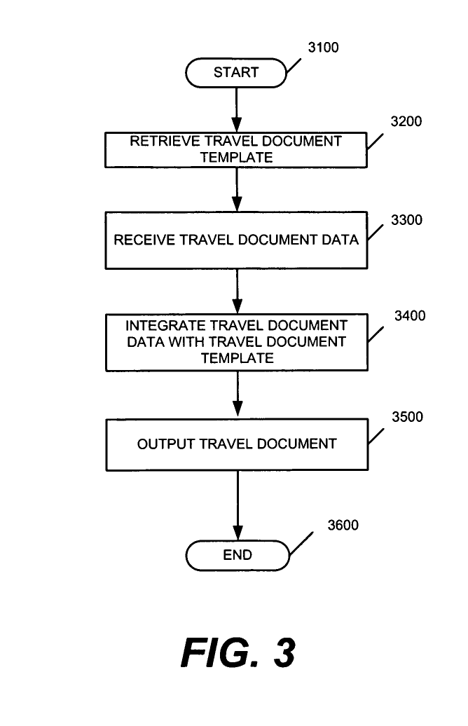

Note that while the travel document printing module 250 is shown as a separate element, any or all of its functions may be performed by the processor 220. The operation of the travel document printing module 250 will be discussed below in relation to the discussion concerning FIG. 3.

FIG. 3 illustrates a flowchart of an exemplary travel document printing process in accordance with embodiments of the disclosure. The method starts at 3100, and continues to 3200 where the travel document printing module 250 retrieves a travel document template. The travel document template may be in a format dictated by an industry standard, such as a “pectab” used by the airline industry. For example, for airline boarding passes, the travel document template may be dictated by the AEA standard. There may also be travel documents 130 templates for ships, trains, etc. The travel documents 130 may be boarding passes, tickets, baggage tags, customs documents, cargo documents, etc.

At step 3300, travel document printing module 250 receives travel document data concerning an individual's travel. This data may be the identification information of the traveler, date of document issuance, dates of travel, departure time, arrival time, boarding time, fare coding, security coding, baggage information, identification information of mode of travel (e.g., flight number/aircraft type, train number/train type, ship number/ship type, etc.), etc.

At 3400, the travel document printing module 250 integrates the travel document data with the travel document template to produce a digital image of one or more travel documents that includes the integrating travel document data and the travel document template. This step may be performed using a PC's operating system's graphical design interface. The graphical design interface may map the template to the standardized format that includes the proper colors, logos, shapes etc. The travel document data may be integrated into the template to form a digital image of the travel document 130.

At step 3500, the travel document printing module 250 outputs one or more travel document 130. The travel documents may be output to an ordinary printer, or electronically to a digital image or an e-mail. For example, the travel documents may be output to output devices 280 such as a laser printer, an ink jet printer, an e-mail device, an electronic image display, a personal digital assistant, a cell phone, etc. The travel documents may be printed on ordinary paper, special paper, or security enhanced paper (e.g., watermarked, hologramed, etc.), for example. The process then goes to step 3600 and ends.

Embodiments as disclosed may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hard wired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of printing travel documents, comprising:
retrieving a travel document template, wherein the travel document template is in a format dictated by an industry standard;
receiving travel document data for an individual's travel;
integrating the individual's travel document data with the travel document template to produce a digital image of one or more travel documents that includes the integrating travel document data and the travel document template; and
outputting the one or more travel document.

2. The method of claim 1, wherein the travel document data includes one or more of identification information of the traveler, date of document issuance, dates of travel, departure time, arrival time, boarding time, fare coding, security coding, baggage information, and identification information of mode of travel.

3. The method of claim 1, wherein the travel documents are for travel on one of an airplane, a ship, and a train and are at least one of boarding passes, tickets, baggage tags, customs documents, and cargo documents.

4. The method of claim 1, wherein the travel documents are printed on one of ordinary paper, special paper, and security enhanced paper.

5. The method of claim 1, wherein the individual's travel document data is integrated with the travel document template created into a digital image using a personal computer's operating system's graphical design interface.

6. The method of claim 1, wherein the industry standard is an Association of European Airlines (AEA) standard.

7. The method of claim 1, wherein the one or more travel documents are output to at least one of a laser printer, an ink jet printer, an e-mail device, an electronic image display, a personal digital assistant, and a cell phone.

8. The method of claim 1, further comprising:
incorporating at least one of a security mark, a logos, and advertising into the digital image.

9. A computer-readable medium storing instructions for printing travel documents, the instructions comprising:
retrieving a travel document template, wherein the travel document template is in a format dictated by an industry standard;
receiving travel document data for an individual's travel;
integrating the individual's travel document data with the travel document template to produce a digital image of one or more travel documents that includes the integrating travel document data and the travel document template; and
outputting the one or more travel document.

10. The computer-readable medium of claim 9, wherein the travel document data includes one or more of identification information of the traveler, date of document issuance, dates of travel, departure time, arrival time, boarding time, fare coding, security coding, baggage information, and identification information of mode of travel.

11. The computer-readable medium of claim 9, wherein the travel documents are for travel on one of an airplane, a ship, and a train and are at least one of boarding passes, tickets, baggage tags, customs documents, and cargo documents.

12. The computer-readable medium of claim 9, wherein the travel documents are printed on one of ordinary paper, special paper, and security enhanced paper.

13. The computer-readable medium of claim 9, wherein the individual's travel document data is integrated with the travel document template created into a digital image using a personal computer's operating system's graphical design interface.

14. The computer-readable medium of claim 9, wherein the industry standard is an Association of European Airlines (AEA) standard.

15. The computer-readable medium of claim 9, wherein the one or more travel documents are output to at least one of a laser printer, an ink jet printer, an e-mail device, an electronic image display, a personal digital assistant, and a cell phone.

16. The computer-readable medium of claim 9, further comprising instructions for:
incorporating at least one of a security mark, a logos, and advertising into the digital image.

17. A travel document printing unit, comprising:
an output device; and
a travel document printing module that retrieves a travel document template, wherein the travel document template is in a format dictated by an industry standard, receives travel document data for an individual's travel, integrates the individual's travel document data with the travel document template to produce a digital image of one or more travel documents that includes the integrating travel document data and the travel document template, and outputs the one or more travel document to the output device.

18. The travel document printing unit of claim 17, wherein the travel document data includes one or more of identification information of the traveler, date of document issuance, dates of travel, departure time, arrival time, boarding time, fare coding, security coding, baggage information, and identification information of mode of travel.

19. The travel document printing unit of claim 17, wherein the travel documents are for travel on one of an airplane, a ship, and a train and are at least one of boarding passes, tickets, baggage tags, customs documents, and cargo documents.

20. The travel document printing unit of claim 17, wherein the output device is a printer that prints the travel documents on one of ordinary paper, special paper, and security enhanced paper.

21. The travel document printing unit of claim 17, wherein the individual's travel document data is integrated with the travel document template created into a digital image using a personal computer's operating system's graphical design interface.

22. The travel document printing unit of claim 17, wherein the industry standard is an Association of European Airlines (AEA) standard.

23. The travel document printing unit of claim 17, wherein the output device is one of a laser printer, an ink jet printer, an e-mail device, an electronic image display, a personal digital assistant, and a cell phone.

24. The travel document printing unit of claim 17, wherein the travel document printing module incorporates at least one of a security mark, a logos, and advertising into the digital image.
